(19) United States
(12) Patent Application Publication
(10) Pub. No.: US 2025/0297498 A1
(43) Pub. Date: Sep. 25, 2025

(54) MOTOR VEHICLE LATCH

(71) Applicant: Kiekert AG, Heiligenhaus (DE)

(72) Inventor: John Dey, Wixom, MI (US)

(73) Assignee: Kiekert AG, Heiligenhaus (DE)

(21) Appl. No.: 18/609,449

(22) Filed: Mar. 19, 2024

(51) Int. Cl. E05B 15/16; C08K 7/06; C08K 7/14; E05B 85/24

(52) U.S. Cl. CPC E05B 15/1635; C08K 7/06; C08K 7/14; E05B 85/243; C08K 2201/004; E05B 2015/165

(57) ABSTRACT

A motor vehicle lock, in particular a motor vehicle door lock. This has one or more high-strength structural components, for example a rotary latch and a pawl. The relevant structural component is made of plastic composite material consisting of fibers in a matrix of a plastic resin or has such a plastic composite material as an essential component. According to the invention, a forged fiber composite material is used as the plastic composite material.

The invention relates to a motor vehicle lock, in particular a motor vehicle door lock, with one or more high-strength structural components, for example a rotary latch and pawl, wherein the relevant structural component is formed from a plastic composite material of fibers in a matrix of a plastic resin, or contains such a plastic composite material as an essential component.—The term “essential component” means a mass or percent by weight of more than 50% by mass or 50% by weight relative to the total weight of the relevant structural component.

Structural components of motor vehicle locks are designed to be high-strength for reasons of security. This means that moduli of elasticity of more than 5000 N/mm² and in particular more than 10,000 N/mm2 are realized at this point, as described in detail in the generic prior art according to DE 20 2006 018 500 U1. This is a motor vehicle lock in which the locking mechanism, essentially consisting of a rotary latch and a pawl, is at least partially made of plastic as the core material. The employed plastic is a high-strength thermoplastic with the aforementioned modulus of elasticity >5000 N/mm² corresponding to 5 GPa and more. In this context, glass-fiber-reinforced polyvinyl sulfide with a glass fiber content of approx. 40% by weight is described as a possible material.

A comparable motor vehicle lock is the subject of EP 3 467 239 A1. In this case too, structural components such as a rotary latch and an associated pawl, which can be made from a plastic composite or a carbon-based material, are explained in paragraph therein. However, there are no further explanations.

In practice and in the predominant state of the art, the mentioned structural components are predominantly made of high-strength steel. This can be attributed to the fact that, due to safety requirements, the locking mechanism consisting of the rotary latch and pawl must be able to withstand tearing forces corresponding to a weight force of half a ton or more, for example. Further processing steps are often required to make such locking mechanism components made of steel suitable for use in the interior of the vehicle lock and to implement the locking mechanism. The locking mechanism components made of steel are often reworked and additionally hardened using heat. In addition, an anti-corrosion coating is regularly applied, and the relevant locking mechanism component is overmolded with plastic in order to positively influence the noise behavior. This can be exemplified by the previously mentioned prior art according to DE 20 2006 018 500 U1.

As a consequence of this, production is characterized by many different processes, which on the one hand drive up production costs and on the other hand are problematic with regard to any scrap or the possibility of recycling. This is where the invention aims to provide an overall remedy.

The invention is based on the technical problem of further developing such a motor vehicle lock and in particular a motor vehicle door lock in such a way that a particularly advantageous and resource-saving manufacturing process is made available, taking into account reduced costs.

In order to solve this technical problem, a motor vehicle lock and in particular a motor vehicle door lock according to the invention is characterized in that a forged fiber composite material is used as the plastic composite material.

In this context, the invention recommends the particularly advantageous use of carbon fibers as fibers. In principle, however, glass fibers can also be used. The relevant fibers are embedded in the matrix of the plastic resin. For this purpose, an epoxy resin is generally used as the plastic resin.

The fibers used at this point typically have a length of 5 mm to 20 mm and are in particular around 15 mm in length. In this way, a plastic composite material is provided which has an isotropic strength. In other words, the strength of the plastic composite material realized in this way is the same or approximately the same in all three spatial directions. This is in contrast to conventional carbon fiber plates, which are usually manufactured by inserting, for example, fabrics made of carbon fiber into molds and coating them with plastic. Such carbon fiber plates have a high strength perpendicular to the orientation of the inserted carbon fiber mat, but not in the direction of the relevant mat.

In contrast, the plastic composite material used according to the invention, consisting of short fibers inserted into the matrix of plastic resin or epoxy resin, is equipped with the same strength regardless of the spatial direction, which makes it ideal as a base material for the high-strength structural components realized in this way in the interior of a motor vehicle lock. It should be emphasized that not only the previously mentioned locking mechanism components such as the rotary latch and pawl can be considered as suitable structural components at this point. In principle, the plastic composite material according to the invention can also be used to manufacture a locking bolt, reinforcement plates, bolts, inertia elements and also to realize levers as components of an actuating lever chain. A lock plate for mounting the locking mechanism components can also be produced therefrom.

In this context, it has also proven to be particularly advantageous if the fiber content by weight in the relevant plastic composite material is approx. 30% to 50% by weight. Very particularly preferably, a fiber content of approximately 42% to 47% by weight has proven to be particularly advantageous. This is because, taking these specifications into account, a plastic composite material is first provided which has a significantly lower density than, for example, high-strength steel with approx. 7.85 to 7.87 g/cm³. In fact, the plastic composite material according to the invention has a density in the range of approx. 1.5 g/cm³. That is, the density is only about 20% compared to high-strength steel. As a result, the weight of a vehicle lock equipped with this can be significantly reduced compared to previous designs.

At the same time, high tensile strengths are achieved, which can exceed values of 150 MPa. The flexural strength is usually in the range above 300 MPa.

The plastic composite material is generally produced from the loose fibers mixed with an epoxy resin in a heated press under pressure. The temperature of the heated press is in a range that corresponds to the melting of the matrix of the plastic resin or epoxy resin, and consequently, the fibers can be distributed as desired inside the matrix.

Here, temperatures for the heated press in the range of approx. 100° C. to 150° C. and possibly more have proven to be favorable, depending on the melting temperature of the matrix. The pressure applied by the heated press to the epoxy resin with the mixed fibers embedded therein may be in the range of a few 10 MPa, but can also be up to 100 MPa and more. In addition, a dwell time of the plastic composite material inside the press of more than 1 min. and in particular of approx. 5 min. to 10 min. is observed in this context and has proven to be particularly favorable.

As a result, a plastic composite material is provided thereby which is brought into its final shape directly in the associated press by a forging process. This shape is one that corresponds to a structural component as part of the motor vehicle lock according to the invention. In this case, the relevant structural component can be produced entirely from the plastic composite material. Then the structural component made from the plastic composite material is immediately ready for use and ready for installation, i.e., no further downstream processing steps are required, in contrast to a rotary latch or pawl made of steel, for example.

In particular, there is no need for additional grinding post-processing or a stainless finish and, in some cases, coating with plastic. This simplifies the manufacturing process, which is limited solely to the described step in which the plastic composite material is forged in the press into the shape of the desired high-strength structural component as a component of the motor vehicle lock according to the invention.

In principle, however, the plastic composite material in question can also constitute an essential component of the relevant high-strength structural component, for example the core of said structural component with a weight proportion of more than 50% by weight of the finished product. It is then possible in principle for the plastic composite material or forged fiber composite material to be additionally equipped with a plastic coating after the described forging process, for example one made of a thermoplastic elastomer. This makes it possible to achieve particularly favorable noise damping, and it is also possible to use the thermoplastic elastomer coating in question additionally as a damping agent in order to avoid hard impacts between individual locking mechanism components.

As a result, a motor vehicle lock and, in particular, a motor vehicle door lock is provided which is particularly lightweight and can be advantageously recycled. All this succeeds in connection with a simply structured manufacturing process, which is characterized by the fact that a forged fiber composite material and in particular a forged carbon fiber composite material is used as the plastic composite material for realizing the one or more high-strength structural components according to the invention. In contrast to previous methods, the forged plastic composite material according to the invention dispenses with a fabric, for example, and instead uses a random arrangement of the loose fibers in the matrix of the resin.

As a result of this, the plastic composite material used according to the invention can be formed into practically any shape with high precision, namely by the described forging process in the heated press under pressure. The structural component realized in this way has a uniform strength in all three spatial directions, i.e., it is equipped with an isotropic strength. At the same time, high strengths or tensile strengths and flexural strengths are observed. In fact, the observed tensile modulus is above 30 GPa and flexural moduli of more than 20 GPa are observed.

All this is achieved while taking into account a low density of only approx. 1.5 g/cm³, so that the vehicle lock made available in this way is particularly lightweight. All this is combined with the easy option of recycling and the fact that reworking or downstream processing steps can be omitted. These are the main advantages.

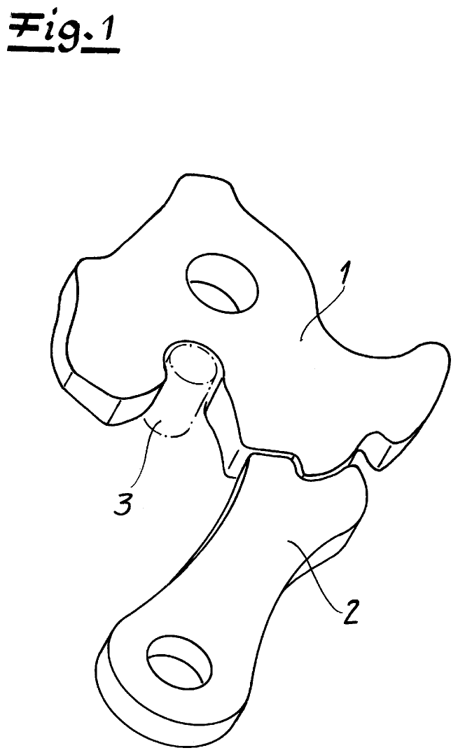

The invention is explained in greater detail below with reference to a drawing which shows only one embodiment. The sole figure, FIG. 1, schematically shows a motor vehicle lock according to the invention, reduced to its two locking mechanism components.

In fact, a motor vehicle lock is shown in FIG. 1, which is equipped with two high-strength structural components 1, 2 in the exemplary embodiment. In the example, the two high-strength structural components 1, 2 are the two locking mechanism components 1, 2, namely a rotary latch 1 and a pawl 2 interacting therewith in the usual way. According to the exemplary embodiment, the two aforementioned structural components 1, 2 are made of a plastic composite material consisting of fibers in a matrix of a plastic resin. According to the exemplary embodiment, the design is such that both structural components or locking components 1, 2 are each made entirely from the relevant plastic composite material.

However, it is also possible that the relevant structural components 1, 2 contain the plastic composite material to be described in more detail below as an essential component, i.e., with a weight or mass fraction of more than 50% by weight or more than 50% by mass. However, this is not shown in detail.

According to the exemplary embodiment, a forged fiber composite material and,

in particular, forged carbon fiber composite material is used as the employed plastic composite material. According to the embodiment example, fibers and in particular carbon fibers are inserted into a matrix of a plastic resin or epoxy resin. This is done in a heated press. With the aid of this heated press, the relevant structural component 1, 2 can now be produced in one go by a forging process under pressure and at the increased temperature described, at a temperature in the range of 100° C. to 150° C. and taking into account a pressure of 10 MPa and more.

The fibers embedded in the matrix of epoxy resin at this point have a length of approx. 15 mm. The fiber content by weight in the composite material is approximately 42% to 47% by weight.

In addition, in the manufacturing in connection with the forging process, the procedure is such that the relevant press, which is not shown in detail, is kept closed for a period of approximately 5 minutes to 10 minutes, taking into account the specified pressure and at the cited temperature, so that the high-strength structural component 1, 2 is subsequently manufactured. According to the exemplary embodiment, the structural component or locking component 1, 2 is characterized by a low density, namely only approx. 1.5 g/cm³, which is significantly lower than the density of high-strength steel. In addition, the structural component 1, 2 produced in this way is ready for immediate use, namely it can be installed directly in a lock case not shown in detail without further processing steps and without additional attachment of a plastic coating, for example, and can interact with a body-side locking bolt 3, for example.

The subject matter of the invention is also the use of a forged fiber composite material for producing one or more high-strength structural components in a motor vehicle lock, and in particular a motor vehicle door lock of the described structure.

### LIST OF REFERENCE NUMBERS

Structural components 1, 2
Locking mechanism components 1, 2
Rotary latch 1
Pawl 2
Locking pin 3

1. A motor vehicle lock comprising:
one or more structural components including at least one of for example a rotary latch and a pawl, wherein at least one of the one or more structural components is formed at least in part of a plastic composite material of fibers in a matrix of a plastic resin,
wherein the plastic composite material comprises a forged fiber composite material.

2. The motor vehicle lock according to claim 1, wherein the fibers include one of carbon fibers or glass fiber.

3. The motor vehicle lock according to claim 1, wherein the fibers have a length of 5 mm to 20 mm.

4. The motor vehicle lock according to claim 1, wherein a proportion by weight of fibers in the plastic composite material is 30% by weight to 50% by weight.

5. The motor vehicle lock according to claim 1, wherein the plastic composite material is produced from loose fibers mixed with an epoxy resin in a heated press under pressure.

6. The motor vehicle lock according to claim 5, wherein a temperature of the press is in a range from 100° C. to 150° C.

7. The motor vehicle lock according to claim 5, wherein a pressure of the heated press is at least 10 MPa.

8. The motor vehicle lock according to claim 5, wherein the plastic composite material remains in the press for more than 1 minute.

9. The motor vehicle lock according to claim 1, wherein the plastic composite material has a density no greater than 20% of a density of steel.

10. (canceled)

11. The motor vehicle lock according to claim 1, wherein the fibers have a length of 15 mm.

12. The motor vehicle lock according to claim 1, wherein a proportion by weight of fibers in the plastic composite material is 42% by weight to 47% by weight.

13. The motor vehicle lock according to claim 5, wherein a pressure of the heated press is at least 100 MPa.

14. The motor vehicle lock according to claim 5, wherein the plastic composite material remains in the press for 5 minutes to 10 minutes.

15. The motor vehicle lock according to claim 1, wherein the plastic composite material has a density of 1.5 g/cm³.

16. The motor vehicle lock according to claim 1, wherein the at least one of the one or more structural components that is made of the plastic composite material has a mass or percent by weight of more than 50% by mass or by weight relative to a total mass or weight of the at least one of the one or more structural components that is made of the plastic composite material.

17. The motor vehicle lock according to claim 1, wherein the at least one of the one or more structural components that is made of the plastic composite material has a modulus of elasticity of at least 5000 N/mm².
